(19) United States
(12) Patent Application Publication
(10) Pub. No.: US 2013/0251075 A1
(43) Pub. Date: Sep. 26, 2013

(54) SOFT DECISION BIT DETECTION AND DEMODULATION METHOD FOR DIGITAL MODULATION METHOD

(71) Applicants: Young Min KIM, Jeonbuk (KR); Hyoung Soo LIM, Daejeon-si (KR); Heung Mook KIM, Daejeon-si (KR)

(72) Inventors: Young Min KIM, Jeonbuk (KR); Hyoung Soo LIM, Daejeon-si (KR); Heung Mook KIM, Daejeon-si (KR)

(73) Assignee: Electronics and Telecommunications Research Institute, Daejeon-si (KR)

(21) Appl. No.: 13/566,416

(22) Filed: Aug. 3, 2012

(30) Foreign Application Priority Data
Mar. 20, 2012 (KR) 10-2012-0028072

(51) Int. Cl. H04L 27/06

(52) U.S. Cl. 375/341

(57) ABSTRACT

In the present invention, deciding M final soft decision bit values includes a first step of securing an I channel value and a Q channel value of the received transmission signal, a second step of securing initial soft decision bit values for a first bit and a second bit by using the secured I channel value and the secured Q channel value, a third step of cyclically securing initial soft decision bit values for a third bit to an M^{th} bit by using the initial soft decision bit values for the first bit and the second bit, and a fourth step of securing final soft decision bit values by multiplying the secured initial soft decision bit values by a gain, wherein the gain is calculated based on a reliability adjustment value of the initial soft decision bit values.

Priority to Korean patent application number 10-2012-0028072 filed on Mar. 20, 2012, the entire disclosure of which is incorporated by reference herein, is claimed.

### BACKGROUND OF THE INVENTION

1. Field of the Invention

The present invention relates to a soft decision bit detection and demodulation method in the reception terminal of a system including both error correction codes and a digital modulation method.

2. Discussion of the Related Art

As another characteristic of a recent digital communication system, error correction codes are used in almost all systems in order to overcome several deterioration conditions occurring in a channel. There is a tendency for more systems to use turbo codes or Low Density Parity Check (LDPC) codes capable of achieving very excellent decoding performance as a repetitive decoding scheme. In particular, an essential condition in codes for improving performance, such as turbo codes or LDPC code, by using a repetitive decoding method is that the input of a decoder must a soft decision bit value. To this end, the demodulator of a reception terminal must be able to effectively calculate a soft decision detection value for several bits that form a reception symbol.

According to the above necessity, there have been proposed technology for calculating a log likelihood ratio by calculating the distance from a soft decision boundary line between modulation symbols based on a soft decision detection value for bits that form each of the modulation symbols and a decoding method using a max log map by finding a maximum proximity constellation symbol point, but the technology and the decoding method appear to have lower performance than a maximum likelihood decoding method.

### SUMMARY OF THE INVENTION

An object of the present invention is to propose linear detection using a soft decision detection method employing a hard decision boundary which is capable of maintaining a conventional modulation and demodulation system and also securing performance using a simple method.

A soft decision demodulation method according to an embodiment of the present invention includes receiving a transmission signal modulated in an M (M is a natural number equal to or greater than 3) modulation order; deciding M final soft decision bit values from the received transmission signal; and restoring the transmission signal based on the final soft decision bit values. Here, deciding the M final soft decision bit values includes a first step of securing the I channel value and the Q channel value of the received transmission signal; a second step of securing initial soft decision bit values for a first bit and a second bit by using the secured I channel value and the secured Q channel value; a third step of cyclically securing initial soft decision bit values for a third bit to an M^{th} bit by using the initial soft decision bit values for the first bit and the second bit; and a fourth step of securing final soft decision bit values by multiplying the secured initial soft decision bit values by a gain, wherein the gain is calculated based on a reliability adjustment value of the initial soft decision bit values.

Furthermore, the initial soft decision bit values for the first bit and the second bit may be calculated by taking a real number part and an imaginary number part for a received complex symbol s.

Furthermore, if a modulation method is an M-ary QAM method, the initial soft decision bit values for the third or higher bits may be calculated according to Equation 1.

$${\hat{b}}_{2 i + 1} = ( \vert {\tilde{b}}_{2 ( i - 1 ) + 1} \vert - {2}^{\frac{lo {g}_{2 M}}{2} - i} A ) \\ {\hat{b}}_{2 i + 2} = ( \vert {\tilde{b}}_{2 ( i - 1 ) + 2} \vert - {2}^{\frac{lo {g}_{2} M}{2} - i} ) , i \geq 1 \qquad 〈 Equation 1 〉$$

In Equation 1, A is a smallest power level of the I channel and the Q channel of the M-ary QAM method.

Furthermore, if a modulation method is an M-ary PSK modulation method, the third step may include the steps of calculating a size and phase of a received complex symbol s; deciding an initial phase value θ₂; calculating a phase value θᵢ (i is a natural number equal to or greater than 3) according to Equation 2; and calculating an initial soft decision bit value by using the calculated phase value θᵢ and Equation 3.

$$\begin{matrix}{θ}_{i} = \vert {θ}_{i - 1} \vert - \frac{π}{{2}^{i - 1}} & 〈 Equation 2 〉 \\ {\tilde{b}}_{i} = \vert s \vert sin ( {θ}_{i} ) & 〈 Equation 3 〉\end{matrix}$$

Furthermore, the gain may be proportional to a size of a fading coefficient of a radio channel and may be inversely proportional to a variance of Gaussian noise.

Furthermore, the reliability adjustment value may be previously set for each bit.

Furthermore, the gain gi may be Equation 4.

<Equation 4>

gᵢ=−2αᵢ|h|/σ²

In Equation 4, h is a size of a fading coefficient of a channel, σ² is a variance of Gaussian noise and αᵢ is the reliability adjustment value for each bit. Furthermore, if a modulation method is an 8 PSK method, the final soft decision bit values may be calculated according to Equation 5.

$${\hat{b}}_{1} = - \frac{2}{{σ}^{2 }} Re \{ r \} , {\hat{b}}_{2} = - \frac{2}{{σ}^{2}} Im \{ r \} \\ {\hat{b}}_{3} = - α \times \frac{2}{{σ}^{2}} \frac{( \vert Im \{ r \} \vert - \vert Re \{ r \} \vert )}{\sqrt{2}} \qquad 〈 Equation 5 〉$$

In Equation 5, σ² is a variance of Gaussian noise and α is the reliability adjustment value.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 shows the construction of a transceiver system using error correction codes and a digital modulation method according to an embodiment of the present invention;

FIG. 2 is a detailed construction of an M-ary QAM modulator according to an embodiment of the present invention;

FIG. 3 is a detailed construction of an M-ary PSK modulator according to an embodiment of the present invention;

FIG. 4 shows an 8-PSK hard decision boundary and the construction of bits for illustrating a reliability adjustment method; and

FIG. 5 is a diagram showing a comparison of BER performance of a turbo-coded 8-PSK method according to a demodulation method in an AWGN channel according to an embodiment of the present invention.

FIG. 6 is a diagram showing a comparison of BER performance of 16-QAM method according to a demodulation method in a Rayleigh channel (flat fading) according to an embodiment of the present invention.

### DETAILED DESCRIPTION OF THE EMBODIMENTS

Hereinafter, embodiments of the present invention are described in detail with reference to the accompanying drawings. The present embodiments are provided to complete the disclosure of the present invention and to allow those having ordinary skill in the art to fully understand the scope of the present invention. The shapes of elements in the drawings may be enlarged in order to highlight a clearer description, and the same reference numbers are used throughout the drawings to refer to the same parts.

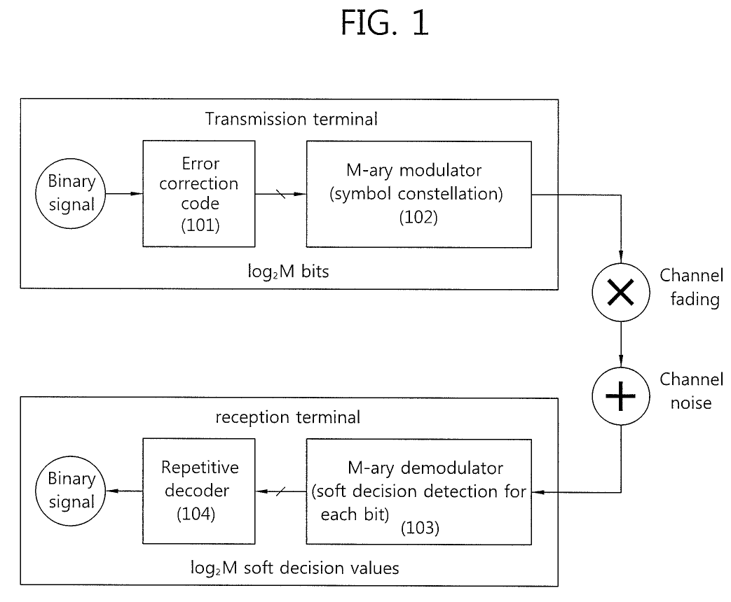

FIG. 1 shows the construction of a transceiver system using error correction codes and a digital modulation method according to an embodiment of the present invention.

Referring to FIG. 1, the error correction coder 101 of a transmission terminal adds parity information for correcting errors occurring in a channel to binary information bits and supplies coded binary bits to an M-ary modulator 102. The M-ary modulator 102 constellates M bits to one symbol according to an M-ary modulation method that is suitable for a current channel state in response to a control signal from a higher layer and transmits the one symbol to the channel. Fading is applied to the symbol in the channel. The M-ary demodulator 103 of a reception terminal outputs the received signal to which noise has been added to a repetitive decoder 104 as M soft decision bit values. The repetitive decoder 104 for error correction extracts the original information bits by repetitively performing decoding using M soft decision bit values.

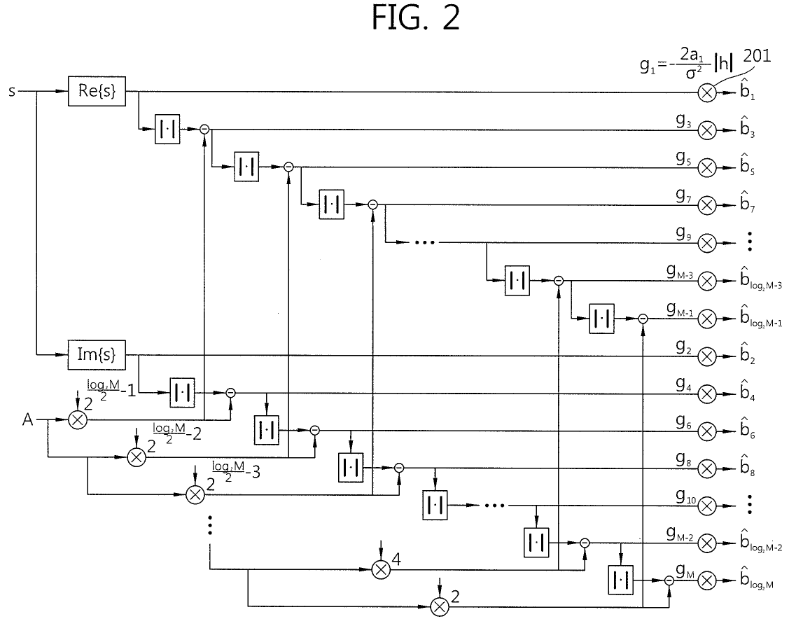

FIG. 2 is a detailed construction of an M-ary QAM modulator according to an embodiment of the present invention.

Referring to FIG. 2, a soft decision bit detection and demodulation method for a modulation system including a digital modulation method according to the present invention includes a first step of calculating the I channel value of a received signal and the Q channel value of the received signal. The soft decision bit detection and demodulation method further includes a second step of taking the size of the calculated I channel and the size of the calculated Q channel as initial soft decision bit values for first and second bits. The soft decision bit detection and demodulation method further includes a third step of cyclically calculating initial soft decision bit values for third bit or higher bits by using the initial soft decision bit values for the first and the second bits. The soft decision bit detection and demodulation method further includes a fourth step of multiplying all the initial soft decision bit values by a specific gain and outputting final soft decision bit values. The initial soft decision values for the first and the second bits calculated in the second step are calculated according to Equation 1 below by taking a real number part and an imaginary number part for a received complex symbol s.

[Equation 1]

\tilde{b}₁=Re{s}

\tilde{b}₂=Im{s}

If a modulation method used in the third step is an M-ary QAM method, the initial soft decision bit values for the third or higher bits are calculated according to Equation 2 below.

$${\hat{b}}_{2 i + 1} = ( \vert {\tilde{b}}_{2 ( i - 1 ) + 1} \vert - {2}^{\frac{lo {g}_{2} M}{2} - i} A ) \\ {\hat{b}}_{2 i + 2} = ( \vert {\tilde{b}}_{2 ( i - 1 ) + 2} \vert - {2}^{\frac{lo {g}_{2} M}{2} - i} A ) , i \geq 1 \qquad [ Equation 2 ]$$

In Equation 2, A indicates the smallest power level of the I channel and the Q channel using the M-ary QAM method.

Meanwhile, if the modulation method used in the third step is an M-ary PSK modulation method, the third step includes first to fourth sub-steps.

In the first sub-step, the size and phase of the reception symbol s is calculated according to Equation 3 below.

$$\vert s \vert = \sqrt{Re {\{ s \}}^{2} + Im {\{ s \}}^{2}} \\ {θ}_{s} = {tan}^{- 1} ( \frac{\vert Im \{ s \} \vert}{\vert Re \{ s \} \vert} ) \qquad [ Equation 3 ]$$

In the second sub-step, an initial phase value is performed like θ₂=θₛ.

In the third sub-step, a phase value necessary for a current step is calculated as in Equation 4 by using a phase value in a previous step.

$${θ}_{i} = \vert {θ}_{i - 1} \vert - \frac{π}{{2}^{i - 1}} \qquad [ Equation 4 ]$$

Furthermore, in the fourth sub-step, an initial soft decision value is calculated according to Equation 5 below by applying sin to the phase value calculated by Equation 4 and multiplying the size of the reception symbol.

[Equation 5]

\tilde{b}ᵢ=|s|sin(θᵢ)

In the fourth step, a final soft decision bit value for an i^{th} bit, such as Equation 6, may be obtained by multiplying a gain (−2αᵢ|h|/σ²).

$${\hat{b}}_{i} = - \frac{2 {α}_{i}}{{σ}^{2}} \vert h \vert {\tilde{b}}_{i} \qquad [ Equation 6 ]$$

In Equation 6, |h| is the size of the fading coefficient of a channel, σ² is a variance of Gaussian noise, and αᵢ is a reliability adjustment value for each bit.

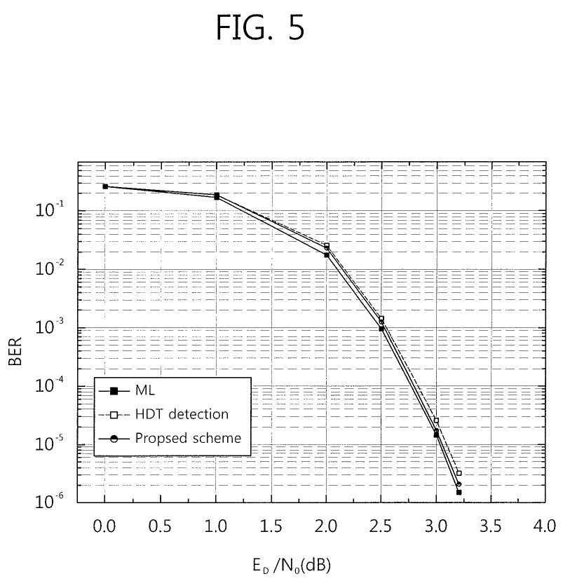

The reliability adjustment value for each bit is a set value determined by experiments. The soft decision bit value becomes smaller than the existing value by multiplying the gain into which the reliability adjustment value for each bit has been incorporated. Experiments showed that performance becomes better when the soft decision bit value becomes smaller than the existing value. FIG. 5 shows the results of the experiments.

FIG. 5 is a diagram showing a comparison of BER performance of a turbo-coded 8-PSK method according to a demodulation method in an AWGN channel according to an embodiment of the present invention.

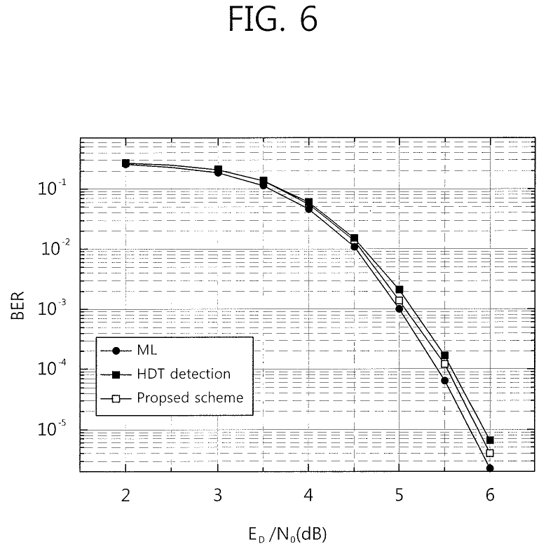

FIG. 6 is a diagram showing a comparison of BER performance of 16-QAM method according to a demodulation method in a Rayleigh channel (flat fading) according to an embodiment of the present invention.

Referring to FIG. 5, turbo codes used in simulations were duo-binary turbo codes defined by an error correction code method having the IEEE WiMaX standard, the coding rate was 1/3, a frame size was 396 bits, and the number of times of maximum repetitive decoding was 8.

Referring to FIG. 6, in case of 16-QAM, a performance gain can be achieved by making different reliability in such a way to multiply bits 3 and 4 by an experimentally obtained α in the state in which reliability of bits 1 and 2 remains intact. The reason why each of the bits 1 and 2 and the bits 3 and 4 forms a pair is that in QAM, a real number part and an imaginary number part show soft decision detection having the same form

Equation 7 below shows a conventional soft decision detection method using a hard decision boundary in 8 PSK. In contrast, Equation 8 shows a soft decision detection method according to an embodiment of the present invention.

$$\begin{matrix}{\hat{b}}_{1} = - \frac{2}{{σ}^{2}} Re \{ r \} , {\hat{b}}_{2} = - \frac{2}{{σ}^{2}} Im \{ r \} \\ {\hat{b}}_{3} = - \frac{2}{{σ}^{2}} \frac{( \vert Im \{ r \} \vert - \vert Re \{ r \} \vert )}{\sqrt{2}} & [ Equation 7 ] \\ {\hat{b}}_{1} = - \frac{2}{{σ}^{2}} Re \{ r \} , {\hat{b}}_{2} = - \frac{2}{{σ}^{2}} Im \{ r \} \\ {\hat{b}}_{3} = - α \times \frac{2}{{σ}^{2}} \frac{( \vert Im \{ r \} \vert - \vert Re \{ r \} \vert )}{\sqrt{2}} & [ Equation 8 ]\end{matrix}$$

Referring to Equation 8, the bit 1 and the bit 2 are the same as the bit 1 and the bit 2 of the conventional soft decision detection method. That is, the bit 1 and the bit 2 have the same reliability. In contrast, reliability is made different by multiplying the bit 3 or higher by a.

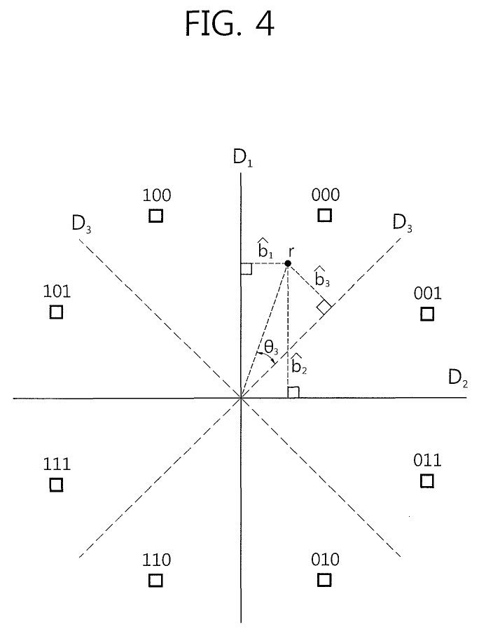

FIG. 4 shows an 8-PSK hard decision boundary and the construction of bits for illustrating a reliability adjustment method.

Referring to FIG. 4, a bit 1 and a bit 2 are decided by only respective hard decision boundaries D1 and D2. In contrast, a bit 3 is determined by a hard decision boundary D3, but the bit 3 has a probability space limited by the hard decision boundaries D1 and D2. In the bit 3 of a received symbol r, the distance between the reception symbol r and the hard decision boundary D3 becomes a soft decision value. However, the bit 3 of the received symbol r has a probability space limited by the hard decision boundary D1. Accordingly, an optimal soft decision value can be obtained by incorporating this limitation condition in a process of obtaining a soft decision value. Likewise, in M-ary QAM, an optimal channel gain value can be obtained by incorporating the limitation condition. In Equation 8, a of the bit 3 can be determined as 0.900185 through experiments by employing the above principle.

In accordance with the present invention, soft decision bit values can be outputted with a low computational load only a gain 201 multiplied in a soft decision bit detection demodulator using the existing hard decision boundary is modified. Likewise, this effect is applied to an M-ary PSK modulator.

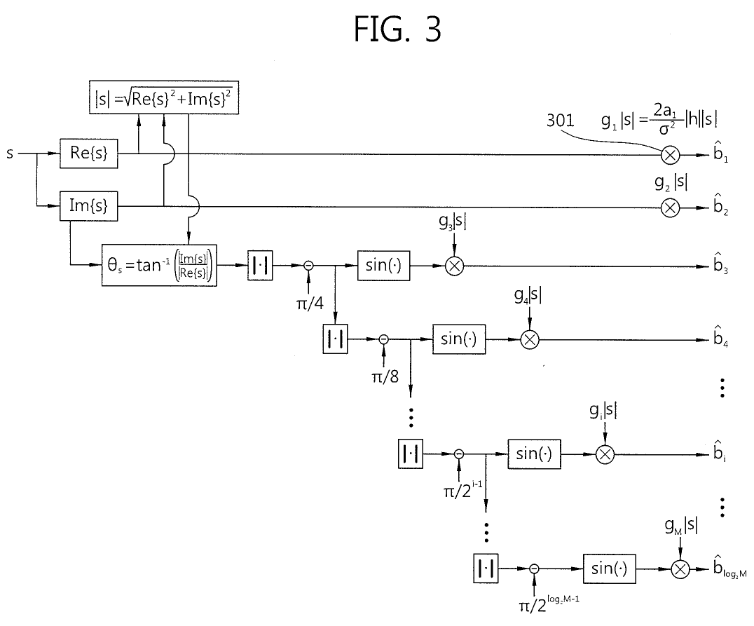

FIG. 3 is a detailed construction of an M-ary PSK modulator according to an embodiment of the present invention.

Referring to FIG. 3, soft decision values can be outputted with the same computational load as that of the existing method because only a gain 301 multiplied using a soft decision bit detection demodulator using a hard decision boundary is modified.

The soft decision bit detection and demodulation method according to the present invention is advantageous in that performance better than that of the prior art can be obtained by only a simple operation of changing reliability between different bits, while calculating a soft decision value for each bit based on an I channel value and a Q channel value.

The embodiments of the present invention described above and shown in the drawings should not be construed as limiting the technical spirit of the present invention. The scope of the present invention is restricted by only the claims, and a person having ordinary skill in the art to which the present invention pertains may improve and modify the technical spirit of the present invention in various forms. Accordingly, the modifications and modifications will fall within the scope of the present invention as long as they are evident to those skilled in the art.

What is claimed is:

1. A soft decision demodulation method, comprising:
receiving a transmission signal modulated in an M (M is a natural number equal to or greater than 3) modulation order;
deciding M final soft decision bit values from the received transmission signal; and
restoring the transmission signal based on the final soft decision bit values,
wherein deciding the M final soft decision bit values comprises:
a first step of securing an I channel value and a Q channel value of the received transmission signal;
a second step of securing initial soft decision bit values for a first bit and a second bit by using the secured I channel value and the secured Q channel value;
a third step of cyclically securing initial soft decision bit values for a third bit to an M^{th} bit by using the initial soft decision bit values for the first bit and the second bit; and
a fourth step of securing final soft decision bit values by multiplying the secured initial soft decision bit values by a gain,
wherein the gain is calculated based on a reliability adjustment value of the initial soft decision bit values.

2. The soft decision demodulation method as claimed in claim 1, wherein the initial soft decision bit values for the first bit and the second bit are calculated by taking a real number part and an imaginary number part for a received complex symbol s.

3. The soft decision demodulation method as claimed in claim 1, wherein if a modulation method is an M-ary QAM method, the initial soft decision bit values for the third or higher bits are calculated according to Equation 1.
$${\hat{b}}_{2 i + 1} = ( \vert {\tilde{b}}_{2 ( i - 1 ) + 1} \vert - {2}^{\frac{lo {g}_{2} M}{2} - i} A ) \\ {\hat{b}}_{2 i + 2} = ( \vert {\tilde{b}}_{2 ( i - 1 ) + 2} \vert - {2}^{\frac{lo {g}_{2} M}{2} - i} A ) , i \geq 1 \qquad 〈 Equation 1 〉$$
In Equation 1, A is a smallest power level of the I channel and the Q channel of the M-ary QAM method.

4. The soft decision demodulation method as claimed in claim 1, wherein if a modulation method is an M-ary PSK modulation method, the third step comprises the steps of:
calculating a size and phase of a received complex symbol s;
deciding an initial phase value θ₂;
calculating a phase value θᵢ (i is a natural number equal to or greater than 3) according to Equation 2; and
calculating an initial soft decision bit value by using the calculated phase value θᵢ and Equation 3.
$$\begin{matrix}{θ}_{i} = \vert {θ}_{i - 1} \vert - \frac{π}{{2}^{i - 1}} & 〈 Equation 2 〉 \\ {\tilde{b}}_{i} = \vert s \vert sin ( {θ}_{i} ) & 〈 Equation 3 〉\end{matrix}$$

5. The soft decision demodulation method as claimed in claim 1, wherein the gain is proportional to a size of a fading coefficient of a radio channel and is inversely proportional to a variance of Gaussian noise.

6. The soft decision demodulation method as claimed in claim 1, wherein the reliability adjustment value is previously set for each bit.

7. The soft decision demodulation method as claimed in claim 1, wherein the gain gᵢ is decided by using Equation 4.
<Equation 4>
gᵢ=−2αᵢ|h|/σ²
In Equation 4, |h| is a size of a fading coefficient of a channel, σ² is a variance of Gaussian noise and αᵢ is the reliability adjustment value for each bit.

8. The soft decision demodulation method as claimed in claim 1, wherein if a modulation method is an 8 PSK method, the final soft decision bit values are calculated according to Equation 5.
$${\hat{b}}_{1} = - \frac{2}{{σ}^{2}} Re \{ r \} , {\hat{b}}_{2} = - \frac{2}{{σ}^{2}} Im \{ r \} \\ {\hat{b}}_{3} = - α \times \frac{2}{{σ}^{2}} \frac{( \vert Im \{ r \} \vert - \vert Re \{ r \} \vert )}{\sqrt{2}} \qquad 〈 Equation 5 〉$$
In Equation 5, σ² is a variance of Gaussian noise and α is the reliability adjustment value.
